(19) United States
(12) Patent Application Publication
(10) Pub. No.: US 2006/0168379 A1
(43) Pub. Date: Jul. 27, 2006

(54) Method, system, and apparatus for link latency management

(76) Inventors: Tim Frodsham, Portland, OR (US); Michael J. Tripp, Forest Grove, OR (US); David J. O'Brien, Portland, OR (US); Navada Herur Muraleedhara, Santa Clara, CA (US); Naveen Cherukuri, San Jose, CA (US); Sanjay Dabral, Palo Alto, CA (US); David S. Dunning, Portland, OR (US); Theodore Z. Schoenborn, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/011,301

(22) Filed: Dec. 13, 2004

(51) Int. Cl. G06F 13/00

(52) U.S. Cl. 710/107

(57) ABSTRACT

A link latency management for a high-speed point-to-point network (pTp) is described The link latency management facilitates calculating latency of a serial interface by tracking a round trip delay of a header that contains latency information. Therefore, the link latency management facilitates testers, logic analyzers, or test devices to accurately measure link latency for a point-to-point architecture utilizing a serial interface.

### BACKGROUND OF THE INVENTION

1. Field of the Invention

The present invention relates to serial type interfaces that require link latency management for deterministic operation.

2. Description of the Related Art

Current systems are based on the Front Side Bus (FSB) utilize a common clock based interface. Thus, determinism and latency are known quantities. In contrast, serial type interfaces have a link latency that is no longer constant. Hence, determinism and repeatability require diligent design and test support to insure accurate deterministic operation.

### BRIEF DESCRIPTION OF THE SEVERAL VIEWS OF THE DRAWINGS

Subject matter is particularly pointed out and distinctly claimed in the concluding portion of the specification. The claimed subject matter, however, both as to organization and method of operation, together with objects, features, and advantages thereof, may best be understood by reference to the following detailed description when read with the accompanying drawings in which:

FIG. 1 is a protocol architecture as utilized by one embodiment.

FIG. 2 is a block diagram of an apparatus for a physical interconnect utilized in accordance with the claimed subject matter.

FIG. 3 illustrates a timing diagram for a method for link latency management as utilized by an embodiment.

FIG. 4 is multiple embodiments of a system as utilized by multiple embodiments.

### DETAILED DESCRIPTION OF THE INVENTION

A method, apparatus, and system for link latency management for a high speed point to point network (pTp) is described in the following description, for purposes of explanation, numerous details are set forth in order to provide a thorough understanding of the present invention. However, it will be apparent to one skilled in the art that these specific details are not required in order to practice the present invention.

An area of current technological development relates to reliability, availability, and serviceability (RAS). As previously described, current systems are based on the Front Side Bus (FSB) utilize a common clock based interface. Thus, determinism and latency are known quantities. In contrast, serial type interfaces have a link latency that is no longer constant.

The claimed subject matter facilitates calculating latency of the serial interface by tracking a round trip delay of a header that contains latency information. Therefore, the claimed subject matter facilitates testers, logic analyzers, or test devices to accurately measure link latency for a point-to-point architecture utilizing a serial interface. Consequently, PSMI traces and RTL traces are generated.

In one embodiment, the pTp architecture is defined by Intel's Common System Interface (CSI) and supports a layered protocol scheme, which is discussed in further detail in the next paragraph. Figure one illustrates one example of a cache coherence protocol's abstract view of the underlying network. One example of a cache coherence protocol is described in pending application P18890 filed in 2004.

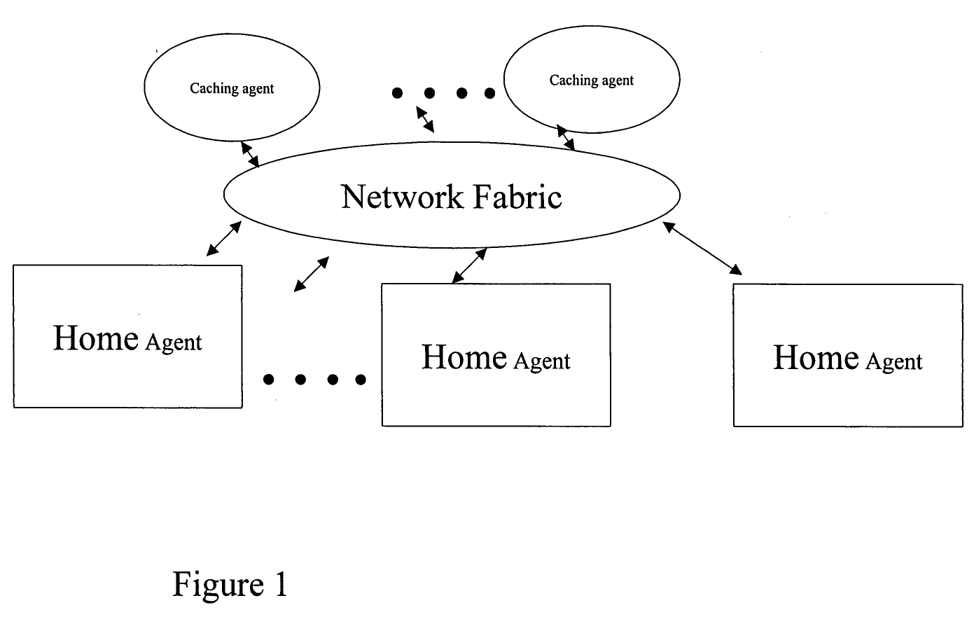

FIG. 1 is a protocol architecture as utilized by one embodiment. The architecture depicts a plurality of caching agents and home agents coupled to a network fabric. For example, the network fabric adheres to a layered protocol scheme and may comprise either or all of: a link layer, a physical layer, a protocol layer, a routing layer, a transport layer. The fabric facilitates transporting messages from one protocol (home or caching agent) to another protocol for a point-to-point network. In one aspect, the figure depicts a cache coherence protocol's abstract view of the underlying network.

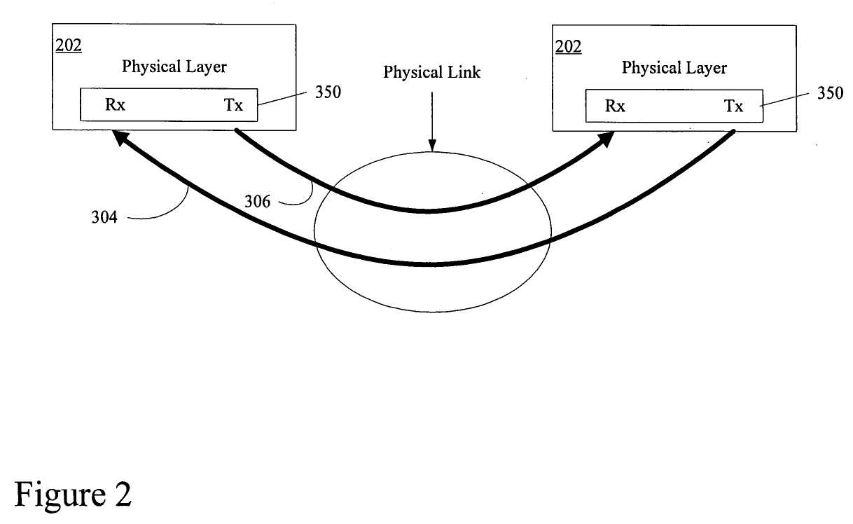

FIG. 2 is a block diagram of an apparatus for a physical interconnect utilized in accordance with the claimed subject matter. In one aspect, the apparatus depicts a physical layer for a cache-coherent, link-based interconnect scheme for a processor, chipset, and/or IO bridge components. For example, the physical interconnect may be performed by each physical layer of an integrated device. Specifically, the physical layer provides communication between two ports over a physical interconnect comprising two uni-directional links. Specifically, one uni-directional link 304 from a first transmit port 350 of a first integrated device to a first receiver port 350 of a second integrated device. Likewise, a second uni-directional link 306 from a first transmit port 350 of the second integrated device to a first receiver port 350 of the first integrated device. However, the claimed subject matter is not limited to two unidirectional links. One skilled in the art appreciates the claimed subject matter supports any know signaling techniques, such as, bi-directional links, etc.

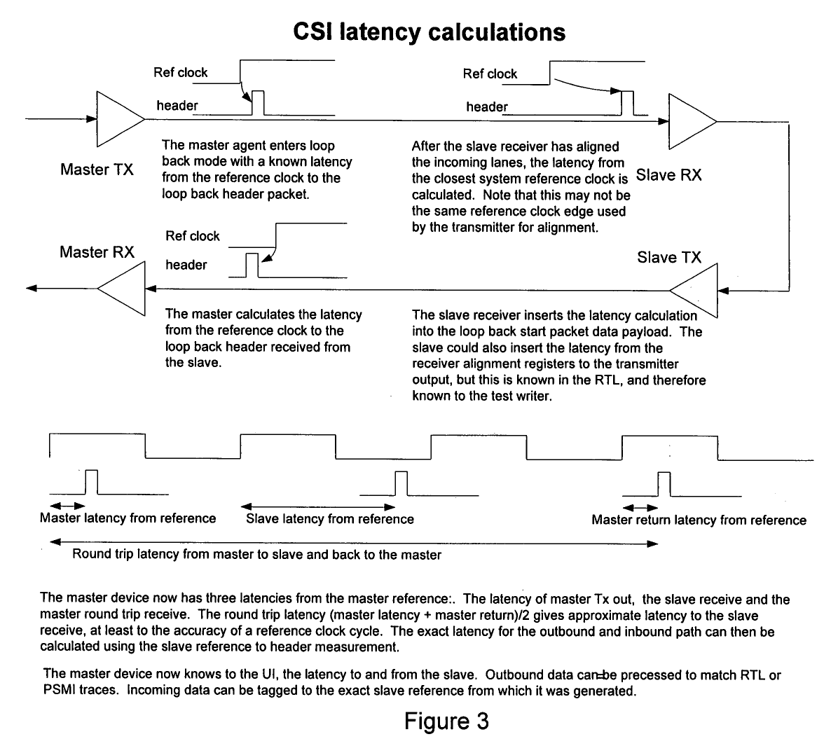

FIG. 3 illustrates a timing diagram for a method for link latency management as utilized by an embodiment. The timing diagram depicts a master agent (depicted as master TX) to enter a loop back mode with a known latency from a reference clock (depicted as Ref clock) to a header packet (depicted as header). For example, the known latency is the difference between the two signals depicted via an arrow. Subsequently, the slave receiver (depicted as slave RX) aligns a plurality of incoming lanes from the transmitter. Consequently, the latency from a system reference clock is calculated. In one embodiment, the system reference clock chosen is the closest system reference clock to the slave receiver and may not be the same reference clock edge used by the master transmitter for alignment. The slave receiver inserts a latency calculation into a loop back start packet data payload. In one embodiment, the slave could also insert a latency from the receiver alignment registers to the transmitter output. Subsequently, the master calculates the latency from the reference clock to the header received from the slave transmitter.

Hence, the master device now has three latencies from the master reference. The latency of master Tx out, the slave receive, and the master round trip receive. The round trip latency (master latency+master return)/2 gives approximate latency to the slave receive, at least to the accuracy of a reference clock cycle. The exact latency for the outbound and inbound path can then be calculated using the slave reference to header measurement. Therefore, the master device now knows the latency to and from the slave. Furthermore, outbound data can be processed to match RTL or PSMI traces. Likewise, incoming data can be tagged to the exact slave reference from which it was generated.

On a final note, the claimed subject matter facilitates link latency management by tracking the cycle in which the packet header was sent from the master transmitter, received by the slave and retransmitted back to the master, the round trip latency can be calculated along with the inbound and outbound latency.

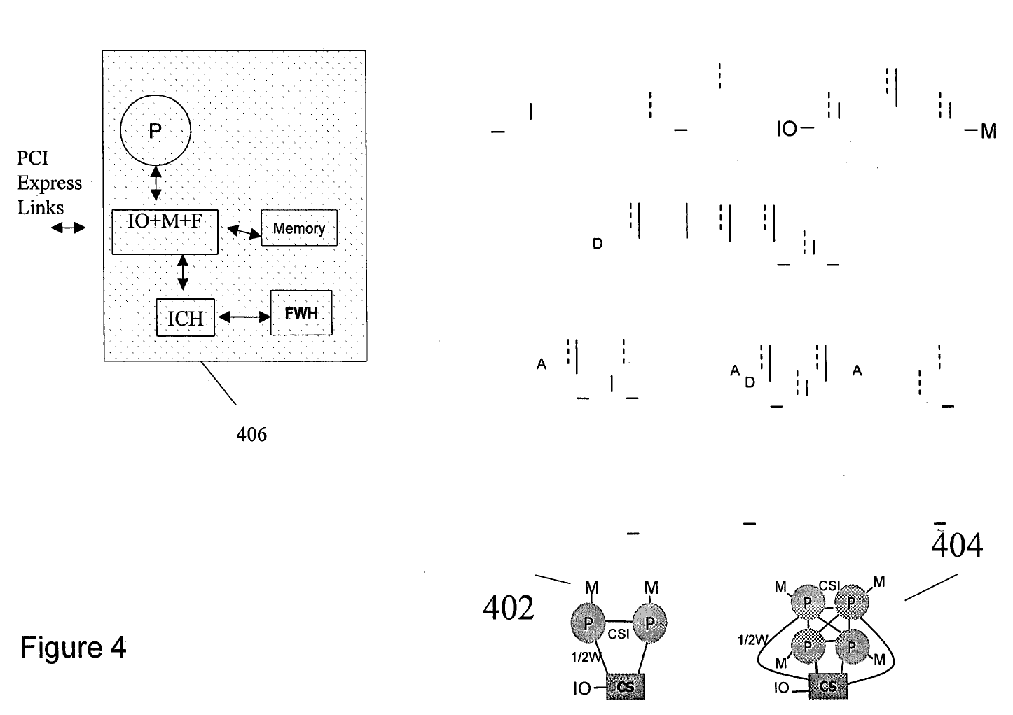

FIG. 4 depicts a point-to-point system with one or more processors. The claimed subject matter comprises several embodiments, one with one processor 406, one with two processors (P) 402 and one with four processors (P) 404. In embodiments 402 and 404, each processor is coupled to a memory (M) and is connected to each processor via a network fabric may comprise either or all of: a link layer, a protocol layer, a routing layer, a transport layer, and a physical layer. The fabric facilitates transporting messages from one protocol (home or caching agent) to another protocol for a point-to-point network. As previously described, the system of a network fabric supports any of the embodiments depicted in connection with FIGS. 1-3.

For embodiment 406, the uni-processor P is coupled to graphics and memory control, depicted as IO+M+F, via a network fabric link that corresponds to a layered protocol scheme. The graphics and memory control is coupled to memory and is capable of receiving and transmitting via PCI Express Links. Likewise, the graphics and memory control is coupled to the ICH. Furthermore, the ICH is coupled to a firmware hub (FWH) via a LPC bus. Also, for a different uni-processor embodiment, the processor would have external network fabric links. The processor may have multiple cores with split or shared caches with each core coupled to a Xbar router and a non-routing global links interface. Thus, the external network fabric links are coupled to the Xbar router and a non-routing global links interface.

Although the claimed subject matter has been described with reference to specific embodiments, this description is not meant to be construed in a limiting sense. Various modifications of the disclosed embodiment, as well as alternative embodiments of the claimed subject matter, will become apparent to persons skilled in the art upon reference to the description of the claimed subject matter. It is contemplated, therefore, that such modifications can be made without departing from the spirit or scope of the claimed subject matter as defined in the appended claims.

1. An apparatus to calculate latency of a serial interface by tracking a delay of a header for a point-to-point architecture comprising:
a reference clock;
a transmitter from a master agent, coupled to a network fabric of the point to point architecture, to enter a mode of operation with a known latency from the reference clock to a header packet; and
a receiver from a slave agent, coupled to a network fabric of the point to point architecture, to align a plurality of incoming lanes from the master agent and to calculate a latency based on a clock.

2. The apparatus of claim 1, wherein the clock for the slave agent to calculate the latency is a system reference clock that is the closest to the slave agent.

3. An apparatus to calculate latency of a serial interface by tracking a round trip delay of a header for a point-to-point architecture comprising:
a reference clock;
a transmitter from a master agent, coupled to a network fabric of the point to point architecture, to enter a loop back mode of operation with a known latency from the reference clock to a header packet;
a receiver from a slave agent, coupled to a network fabric of the point to point architecture, to align a plurality of incoming lanes from the master agent and to calculate a latency based on a clock and to insert a latency calculation into a loop back start packet data payload; and
a master receiver in the master agent to calculate a latency from a reference clock to a header received from the slave.

4. The apparatus of claim 1, wherein the clock for the slave agent to calculate the latency is a system reference clock that is the closest to the slave agent.

5. An apparatus to calculate latency of a serial interface comprising:
a master agent to determine a latency of its transmitter based on a reference clock and a header packet;
a slave receiver to determine a latency based on a closest system reference clock; and
a round trip latency to be calculated based on half of a total of the latency for the master latency and a master round trip receive

6. The apparatus of claim 1, wherein the clock for the slave receiver to calculate the latency is a system reference clock that is the closest to the slave receiver and is not the same as the reference clock used by the master agent.

7. A system that adheres to a pTp architecture and facilitates calculation of latency for a serial interface comprising:
a dynamic memory, coupled to the serial interface to store data for the system;
a master agent to determine a latency of its transmitter based on a reference clock and a header packet;
a slave receiver to determine a latency based on a closest system reference clock; and
a round trip latency to be calculated based on half of a total of the latency for the master latency and a master round trip receive

8. The system of claim 7, wherein the pTp architecture adheres to a layered protocol scheme.

9. A system that adheres to a pTp architecture and facilitates calculation of latency for a serial interface for outbound and inbound latency comprising:
a master agent to determine a latency of its transmitter based on a reference clock and a header packet;
a slave receiver to determine a latency based on a closest system reference clock; and
a round trip latency to be calculated based on half of a total of the latency for the master latency and a master round trip receive

10. The system of claim 9, wherein the pTp architecture adheres to a layered protocol scheme.

11. An apparatus to calculate latency of a serial interface by tracking a cycle of a packet header for a point to point architecture comprising:
a reference clock;
a transmitter from a master agent, coupled to a network fabric of the point to point architecture, to enter a loop back mode of operation with a known latency from the reference clock to a header packet;
a receiver from a slave agent, coupled to a network fabric of the point to point architecture, to align a plurality of incoming lanes that were received from the transmitter of master agent and to calculate a latency based on a clock and to insert a latency calculation into a loop back start packet data payload; and
a master receiver in the master agent to calculate a latency from a reference clock to a header received from the receiver of the slave agent.

12. The apparatus of claim 11, wherein the clock for the slave receiver to calculate the latency is a system reference clock that is the closest to the slave receiver and is not the same as the reference clock used by the master agent.
